(19) United States
(12) Patent Application Publication
(10) Pub. No.: US 2018/0283090 A1
(43) Pub. Date: Oct. 4, 2018

(54) Window Protector

(71) Applicant: Alexander J. Linn, Fullerton, CA (US)

(72) Inventor: Alexander J. Linn, Fullerton, CA (US)

(21) Appl. No.: 15/727,419

(22) Filed: Oct. 6, 2017

Related U.S. Application Data
(60) Provisional application No. 62/405,009, filed on Oct. 6, 2016.

(51) Int. Cl. E06B 7/28; B32B 7/12; B32B 27/32; C09J 7/38

(52) U.S. Cl. CPC E06B 7/28; B32B 7/12; B32B 2307/412; C09J 7/385; B32B 27/32

(57) ABSTRACT

Window Protector, or Window Guardian, is a line of layered, clear film attachments specially designed to adhere to a household window. When the window becomes dirty, the top layer peels off in order to reveal an instantly clean surface. The Window Guardian can be presented in a rectangular or square-shaped form consisting of six to twelve layers of thin, transparent or translucent plastic film.

### CLAIM OF PRIORITY

This patent application claims priority under 35 USC 119 (e)(1) from U.S. Provisional Patent Application Ser. No. 62/405,009 filed Oct. 6, 2016, of Alexander Linn entitled, “Window Guaridan” which is incorporated herein by reference as though the same were set forth in its entirety

### FIELD OF THE INVENTION

The present invention pertains to windows, and more specifically to the field of a line of layered, clear film attachments specially designed to adhere to household windows.

### BACKGROUND OF THE INVENTION

Virtually every structure is equipped with glass windows, whether a home with evenly spaced windows around the perimeter, a small retail store with glass facade, or a skyscraper seemly constructed of nothing but glass. While providing a protective barrier against the elements, windows also serve as a means of allowing the outside to come in. Those stuck behind an office desk or convalescing in the home can gaze dreamily out of windows to view the sun bouncing off streets and buildings, children playing merrily, or the rain as it relentlessly pounds the earth. In addition, windows also allow light to infuse buildings and homes, giving interiors a warm and inviting glow on sunny days.

As many people can attest, keeping windows clean can be a daunting challenge. As these surfaces are easily marred by dirt and fingerprints, many have to constantly wipe them in order for their glass to maintain a pristine appearance. In the home, two windows are especially problematic: sliding glass doors and kitchen windows. Since the former often serves as a busy entrance and exit point, it does not take long for the glass to become filthy from the smears of children's hands and the smudges of pet noses. With kitchen windows, grease and hard water splatters are very challenging to battle, particularly in busy households. As windows are such important components of any home or building, finding a product that could make the cleaning of them easier and less time consuming is essential to many.

The prior art has put forth several designs for window films. Among these are:

U.S. Pat. No. 6,124,044 to Ronald Swidler provides methods for protecting exterior surfaces of automobiles and other products, or components of products, against abrasion, abrasive dust, water, acid rain, etc. The methods involve applying to a surface a protective coating composition comprising an emulsion selected from the group consisting of a vinyl-acrylic copolymer emulsion and a vinyl acetate-ethylene emulsion. The emulsion is dried to form a water-resistant protective coating that can be removed from the underlying surface by peeling when no longer desired.

U.S. Pat. No. 4,636,543 to Bob G. Helton provides a composition solution of resinous polymeric material with the composition including polyvinyl chloride or polyvinyl chloride-polyvinyl acetate copolymer, a saturated vegetable oil release agent typically coconut oil, and a plasticizer such as epoxidized vegetable oil. The composition solution forms a temporary protective coating on glass, metal, and non-porous plastic or painted surfaces unaffected by the solution solvents. Another use for the composition solution is to provide a plastic permanent protective coating for substances such as sheet rock and wood ideal for the mounting of wall paper which when removed may be peeled therefrom without tearing of the sheet rock surface paper.

U.S. Pat. No. 6,705,054 to Thomas Bradley Pelton provides a hurricane resistant window vinyl film having visible light transmission and rip-stop, composed of a double layer of plastic film with a scrim laminated between the two pieces of plastic vinyl coated on one outside side with a pressure-sensitive adhesive that is reusable is then, applied to the inside of a window and it's frame. The strength of the combination of plastic vinyl film, scrim and adhesive are balanced to provide buildings with protection from shattering glass.

None of these prior art references describe the present invention.

### SUMMARY OF THE INVENTION

It is an object of the present invention to provide a line of layered, clear film attachments specially designed to adhere to household windows.

### BRIEF DESCRIPTION OF THE DRAWINGS

FIG. 1 is a top perspective view illustrating a window guardian, constructed in accordance with the present invention, showing multiple layers of sheets with pull tabs.

FIG. 2 is a perspective view illustrating the window guardian, constructed in accordance with the present invention, applied to a sliding glass window.

FIG. 3 is a close-up perspective view illustrating the window guardian, constructed in accordance with the present invention, with pull tabs at two bottom corners to remove the top sheet.

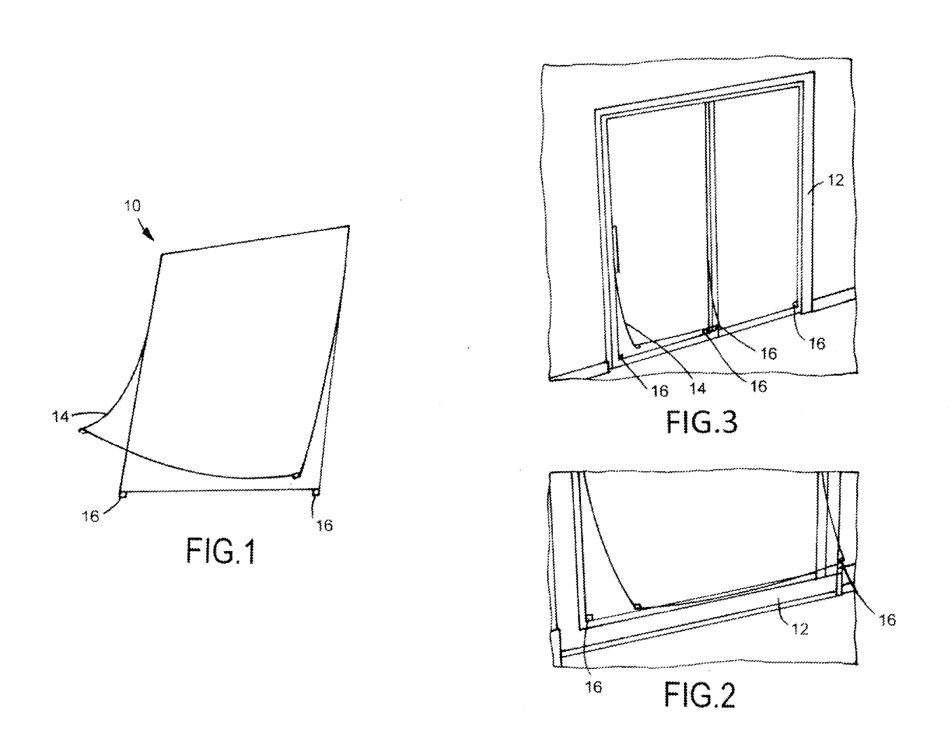

### DETAILED DESCRIPTION OF THE INVENTION

Please refer to the drawings. The present invention, hereinafter referred to as Window Protector, or Window Guardian, is a line of layered, clear film attachments 10 specially designed to adhere to household windows 12. In this manner, when the window becomes dirty, one need only peel off the top layer in order to reveal an instantly clean surface. The Window Guardian can be presented in a rectangular or square-shaped form consisting of six to twelve (6-12) layers of thin, transparent or translucent plastic film, initially offered in blocks measuring approximately three and a half feet (3½′) in length and three and a half to four and a half feet (3½′-4½′) in width, which can be cut to size to accommodate any household window.

To facilitate easy seamless adherence to a window surface, the film attachment 10 is attached to the window by static cling or by a layer isotactic polypropylene or other non-permanent adhesive. The film 10 can be any suitable film including vinyl, acrylic, acetate, polyvinyl chloride Mylar™ or other polyester, for example. The film is thin enough to be flexible, transparent, and easily handled for effective removal of the outer sheet. Suitable thickness ranges from approximately 1 mil up to approximately 8 mil. Each layer 14 of the Window Guardian comes complete with one or two handy pull tabs 16 located in one or two upper corners or lower corners. As constructed, after the Window Guardian 10 is easily installed, one need only pull on the provided tab 16 or tabs 16 to remove the soiled layer 14. Immediately, a new layer 14, showing a pristine window surface is displayed.

The Window Guardian offers a number of benefits and advantages. Foremost, this highly functional product handily eliminates the need to physically clean a window ever again. Cleverly designed, attachable clear film sheets that can be adhered to any window in a matter of minutes, the Window Guardian is perfect for use on such highly exposed glass as sliding glass doors and kitchen windows. As mentioned previously, these windows are more susceptible to constant marring, necessitating cleaning at least once a day. By having to only pull one or two tabs to reveal a sparkling clean surface, homeowners will certainly appreciate that they will not have to gather multiple tools and spend time and energy constantly wiping away grease, food, fingerprints, smears, and other detritus from these windows. Universal in design, the Window Guardian can be customized to cover other glass surfaces in the home, from living room and bedroom windows to even bathroom mirrors. Primarily designed for household purchase and use, professional cleaning services can recommend this handy product to grateful clients, and in turn enjoy the good will that inspires clients to engage them for other jobs.

The Window Guardian will readily simplify a common household chore. With all tools needed at one's fingertips, this product makes window “cleaning” a fun as well as an easy process. Affordably priced, the Window Guardian will be well received by general users, as well as professional cleaning staffs.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A film window covering attachment capable of adhering to household windows, wherein the window has four corners, window covering attachment comprising a rectangular or square-shaped layer of thin, plastic film, capable of being stacked into multiple layers of film.

2. The film window covering of claim 1 wherein the m is transparent.

3. The film window covering of claim 1 wherein the film is translucent.

4. The film window covering of claim 2 measuring approximately three and a half feet (3½′) in length and three and a half to four and a half feet (3½′-4½′) in width, which can be cut to size to accommodate any household window.

5. The film window covering of claim 3 measuring approximately three and a half feet (3½′) in length and three and a half to four and a half feet (3½′-4½′) in width, which can be cut to size to accommodate any household window.

5. The film window covering of claim 2 wherein the film is adhered to windows by static cling.

6. The film window covering of claim 3 wherein the film is adhered to windows by static cling.

7. The film window covering of claim 2 wherein the film is adhered to windows by non-permanent adhesive.

8. The film window covering of claim 3 wherein the film is adhered to windows by non-permanent adhesive.

9. The film window covering of claim 2, wherein the film is made from material selected from the group consisting of: vinyl, acrylic, acetate, polyvinyl chloride, Mylar™ and polyester.

10. The film window covering of claim 3, wherein the film is made from material selected from the group consisting of: vinyl, acrylic, acetate, polyvinyl chloride, Mylar™ and polyester.

11. The film window covering of claim 8, wherein the non-permanent adhesive is isotactic polypropylene.

12. The film window covering of claim 2, wherein the film is approximately 1 mil thick to approximately 8 mil thick.

13. The film window covering of claim 3, wherein the film is approximately 1 mil thick to approximately 8 mil thick.

14. The film window covering of claim 1 wherein the multiple layers of film are from 6 to 12 layers

15. The film window covering of claim 2, further comprising one pull tart, wherein the pull tab is located at one corner.

16. The film window covering of claim 3, further comprising one pull tab, wherein the pull tab is located at one corner.

17. The film window covering of claim 2, further comprising a first pull tab and a second pull tab, wherein the first pull tab is located at one upper corner, and the second pull tab is located at the second upper corner.

18. The film window covering of claim 3, further comprising a first pull tab and a second pull tab, wherein the first pull tab is located at one upper corner, and the second pull tab is located at the second upper corner.

19. The film window covering of claim 2, further comprising a first pull tab and a second pull tab, wherein the first pull tab is located at one lower corner, and the second pull tab is located at the second lower corner.

20. The film window covering of claim 3, further comprising a first pull tab and a second pull tab, wherein the first pull tab is located at one lower corner, and the second pull tab is located at the second lower corner.
